(19) United States
(12) Patent Application Publication
(10) Pub. No.: US 2025/0323512 A1
(43) Pub. Date: Oct. 16, 2025

(54) SEMICONDUCTOR DEVICE, METHOD OF CONTROLLING CELL BALANCE, AND BATTERY PACK

(71) Applicant: Renesas Electronics Corporation, Tokyo (JP)

(72) Inventors: Gen NAGASHIMA, Tokyo (JP); Masaki HOGARI, Tokyo (JP); Yusuke SUGAWARA, Tokyo (JP)

(21) Appl. No.: 19/173,507

(22) Filed: Apr. 8, 2025

(30) Foreign Application Priority Data
Apr. 10, 2024 (JP) 2024-063524

(51) Int. Cl. H02J 7/00

(52) U.S. Cl. CPC H02J 7/0016; H02J 7/0048; H02J 7/005; H02J 7/00716; H02J 7/007182

(57) ABSTRACT

An improved cell balancing is provided. Estimating a charge state of each battery cell at each time point based on a voltage of each cell coupled in series, calculating an integrated value of a current flowing through multiple battery cells during a period between each time point, estimating a maximum capacity of each battery cell based on its charge state at each time point and the integrated value of the current, determining a reference battery cell based on the maximum capacity and charge state of each battery cell, and discharging a battery cell other than the reference battery cell.

### CROSS-REFERENCE TO RELATED APPLICATIONS

The disclosure of Japanese Patent Application No. 2024-063524 filed on Apr. 10, 2024, including the specification, drawings and abstract is incorporated herein by reference in its entirety.

### BACKGROUND

This disclosure relates to a semiconductor device, a cell balance control method, and a battery pack.

Conventionally, it is known that imbalances in the capacity of cells (cell imbalance) occur due to manufacturing variations and individual differences in deterioration over long-term use of battery cells. Charging or discharging in such a state may cause some cells to become overcharged or over-discharged. Furthermore, in cases where some cells become overcharged or over-discharged, charging and discharging may be stopped due to the protective function of the relevant cell. In this case, even though other cells are in a usable state, it may not be possible to fully utilize the original performance.

There are disclosed techniques listed below.
[Patent Document 1] Japanese Unexamined Patent Application Publication No. 2019-058013

In a battery assembly composed of multiple cells, a technique known as cell balancing, which equalizes parameters such as the voltage of each cell to prevent over-discharge and overcharge caused by variations in remaining capacity among cells, is known (see, for example, Patent Document 1). Patent Document 1 discloses a technique for performing cell balance control using a flying capacitor. Moreover, as a method for performing cell balance control, a technique is known where the voltage of each cell is periodically measured, discharge of a cell is carried out when the voltage difference between each cell exceeds the cell balance start threshold, and discharge of a cell is terminated when the voltage difference between each cell falls below the cell balance end threshold.

### SUMMARY

The voltage of a cell changes due to aging, operating temperature, and discharge current. Therefore, there is a problem that even if cell balancing is performed to align the voltages of the cells, the capacities of the cells do not necessarily match. Other objects and novel features will become apparent from the description of this specification and the accompanying drawings.

In one embodiment of the present disclosure, there is provided a semiconductor device comprising: a voltage measurement circuit configured to measure a voltage of each of a first battery cell and a second battery cell coupled in series, a current measurement circuit configured to measure a current flowing through the first battery cell and the second battery cell, and a control unit configured to control a discharge of at least one of the first battery cell and the second battery cell, wherein the control unit estimates a charge rate of each of the first battery cell and the second battery cell at a first time point based on a voltage of each of the first battery cell and the second battery cell measured by the voltage measurement circuit at the first time point, estimates a charge rate of each of the first battery cell and the second battery cell at a second time point, different from the first time point, based on a voltage of each of the first battery cell and the second battery cell measured by the voltage measurement circuit at the second time point, calculates an integrated value of a current flowing through the first battery cell and the second battery cell during a period from the first time point to the second time point,
estimates a maximum capacity of the first battery cell based on the charge rate of the first battery cell at the first time point, the charge rate of the first battery cell at the second time point, and the integrated value of the current, estimates a maximum capacity of the second battery cell based on the charge rate of the second battery cell at the first time point, the charge rate of the second battery cell at the second time point, and the integrated value of the current flowing through the second battery cell, determines a reference battery cell from among the first battery cell and the second battery cell based on the maximum capacity of the first battery cell, the charge rate of the first battery cell, the maximum capacity of the second battery cell, and the charge rate of the second battery cell, and discharge a battery cell other than the reference battery cell among the first battery cell and the second battery cell. Furthermore, in one embodiment of the present disclosure, there is provided a method of cell balance comprising: measuring a voltage of each of a first battery cell and a second battery cell coupled in series, measuring a current flowing through the first battery cell and the second battery cell, estimating a charge rate of each of the first battery cell and the second battery cell at a first time point based on a measured voltage of each of the first battery cell and the second battery cell at the first time point, estimating a charge rate of each of the first battery cell and the second battery cell at a second time point, different from the first time point, based on a measured voltage of each of the first battery cell and second battery cell at the second time point, calculating an integrated value of a current flowing through the first battery cell and second battery cell during a period from the first time point to the second time point, estimating a maximum capacity of the first battery cell based on the charge rate of the first battery cell at the first time point, the charge rate of the first battery cell at the second time point, and the integrated value of the current, estimating a maximum capacity of the second battery cell based on the charge rate of the second battery cell at the first time point, the charge rate of the second battery cell at the second time point, and the integrated value of the current, determining a reference battery cell from among the first battery cell and second battery cell based on the maximum capacity of the first battery cell, the charge rate of the first battery cell, the maximum capacity of the second battery cell, and the charge rate of the second battery cell, and discharging a battery cell other than the reference battery cell among the first battery cell and the second battery cell.

In one embodiment of the present disclosure, there is provided a battery pack comprising: a first battery cell and a second battery cell coupled in series, a voltage measurement circuit configured to measure a voltage of each of the first battery cell and the second battery cell, a current measurement circuit configured to measure a current flowing through the first battery cell and the second battery cell, and a control unit configured to control a discharge of at least one of the first battery cell and the second battery cell, wherein the control unit estimates a charge rate of each of the first battery cell and the second battery cell at a first time point based on a voltage of each of the first battery cell and the second battery cell measured by the voltage measurement circuit at the first time point, estimates a charge rate of each of the first battery cell and the second battery cell at a second time point, different from the first time point, based on a voltage of each of the first battery cell and the second battery cell measured by the voltage measurement circuit at the second time point, calculates an integrated value of a current flowing through the first battery cell and the second battery cell during a period from the first time point to the second time point, estimates a maximum capacity of the first battery cell based on the charge rate of the first battery cell at the first time point, the charge rate of the first battery cell at the second time point, and the integrated value of the current, estimates a maximum capacity of the second battery cell based on the charge rate of the second battery cell at the first time point, the charge rate of the second battery cell at the second time point, and the integrated value of the current, determines a reference battery cell from among the first battery cell and the second battery cell based on the maximum capacity of the first battery cell, the charge rate of the first battery cell, the maximum capacity of the second battery cell, and the charge rate of the second battery cell, and discharges a battery cell other than the reference battery cell among the first battery cell and the second battery cell.

According to one aspect, cell balance can be performed more appropriately.

### BRIEF DESCRIPTION OF THE DRAWINGS

FIG. 1 is a diagram showing an example of a configuration of an equipment according to an embodiment.

FIG. 2 is a flowchart showing an example of a processing of a control unit according to the embodiment.

FIG. 3 is a diagram showing an example of data recorded in a SOC-OCV table according to the embodiment.

FIG. 4 is a diagram showing an example of a relationship between a capacity and voltage of each battery cell according to the embodiment.

FIG. 5 is a timing chart showing an example of a timing of the cell balance processing according to the embodiment.

FIG. 6 is a timing chart showing an example of a timing of the cell balance processing according to the embodiment.

FIG. 7 is a diagram showing an example of a configuration of the control unit according to the embodiment.

### DETAILED DESCRIPTION

The principles of this disclosure are described with reference to several exemplary embodiments. These embodiments are described for illustrative purposes only and without intending to limit the scope of this disclosure, it is understood that they help those skilled in the art to understand and implement this disclosure. The disclosures described in this specification can be implemented in various ways other than those described below.

In the following description and claims, unless otherwise defined, all technical and scientific terms used herein have the same meaning as commonly understood by one of ordinary skill in the art to which this disclosure belongs.

Hereinafter, embodiments of this disclosure will be described with reference to the drawings.

### <Configurations>

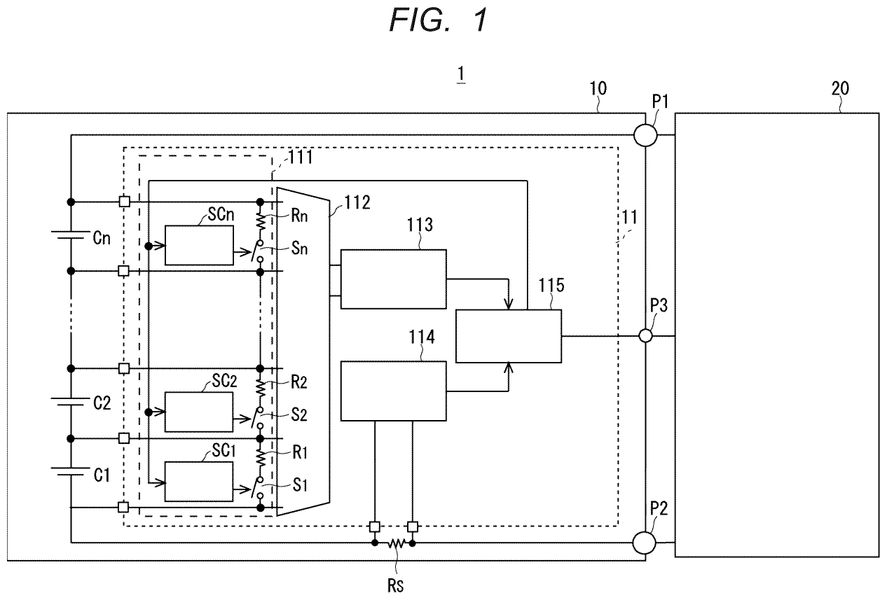

Referring to FIG. 1, a configuration of an equipment 1 according to an embodiment will be described. FIG. 1 is a diagram showing an example of the configuration of the equipment 1 according to the embodiment. The equipment 1 may be, for example, a personal computer, server, household appliance, factory equipment, or vehicle, etc. Examples of vehicles in this disclosure may include, for example, electric vehicles (EV), hybrid electric vehicles (HEV), electric motorcycles, electric assist bicycles, and electric kick scooters, etc.

In the example of FIG. 1, the equipment 1 has a battery pack 10 and a main body 20. The main body 20 is the main body part of the equipment 1. The battery pack 10 may be housed within a casing of the main body 20.

The battery pack 10 has battery cells C1 to Cn (n is an integer of 2 or more) and a battery management Integrated Circuit 11 (battery management IC 11) (an example of a “semiconductor device”). The battery cells C1 to Cn are coupled in series, with a positive side electrically coupled to the main body 20 at connection point P1, and a negative side electrically coupled to the main body 20 at connection point P2. Also, it is electrically coupled to the main body 20 at a communication connection point P3 for notifying the battery status, etc.

The battery management IC 11 has a cell balance section 111, a selection circuit 112, a voltage measurement circuit 113, a current measurement circuit 114, and a control unit 115. The cell balance section 111 has a combination of resistors Ri to Rn, switches Si to Sn, and switch control circuits SCi to SCn for controlling each switch, for each of the battery cells C1 to Cn.

The selection circuit 112 is a circuit that electrically connects only one of the battery cells C1 to Cn, designated by the control unit 115, to the voltage measurement circuit 113.

The voltage measurement circuit 113 measures a voltage of each of the battery cells C1 to Cn coupled in series. In the example of FIG. 1, the voltage measurement circuit 113 is a circuit that measures a voltage of the battery cell selected by the selection circuit 112 from among the battery cells C1 to Cn.

The current measurement circuit 114 measures a current flowing through the battery cells C1 to Cn coupled in series. In the example of FIG. 1, the current measurement circuit 114 measures the current flowing through the battery cells C1 to Cn based on a magnitude of a voltage drop across the sense resistor Rs provided in the electrical circuit to which the battery cells C1 to Cn are coupled. The control unit 115 controls a discharge of at least one of the battery cells C1 to Cn.

### <Processing of the Control Unit 115>

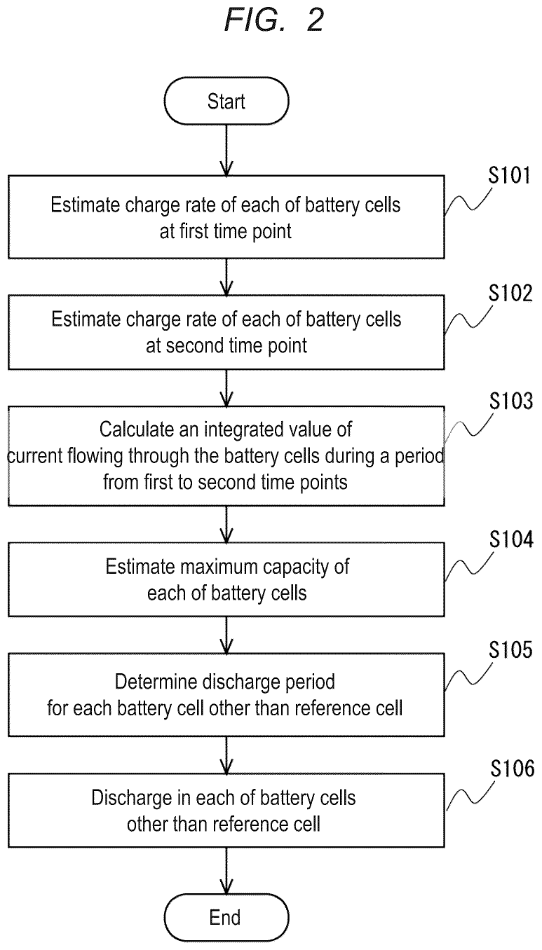

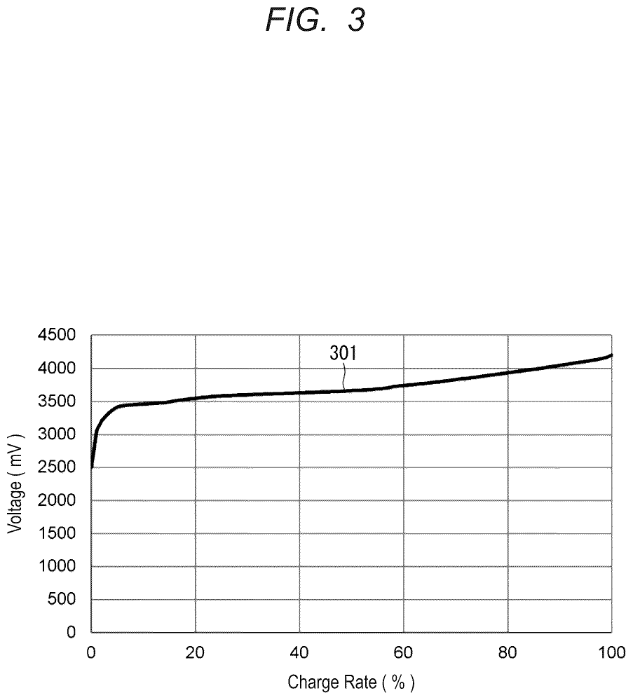

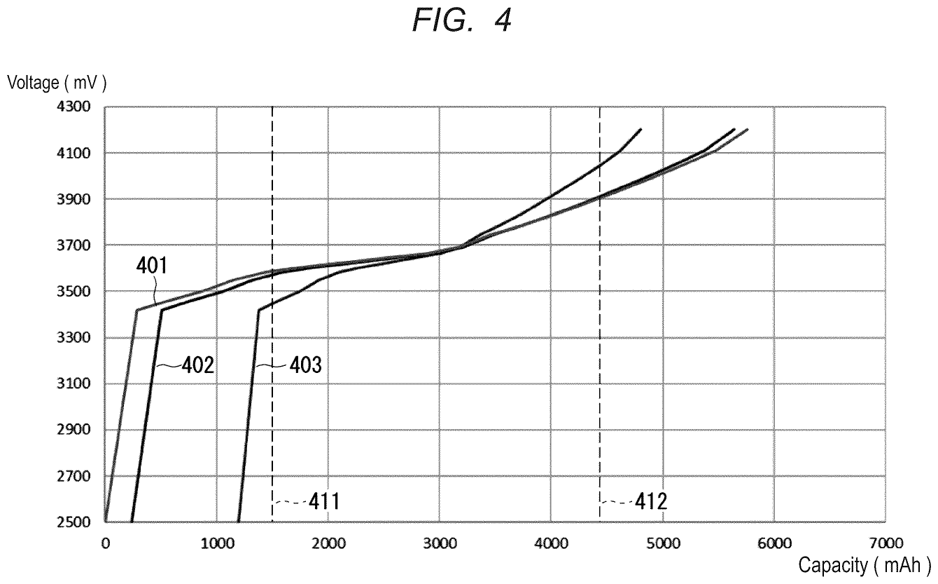

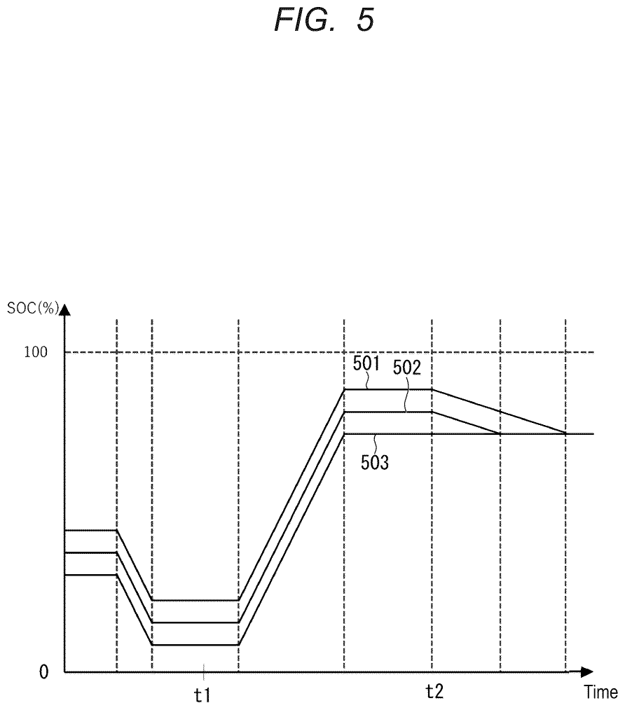

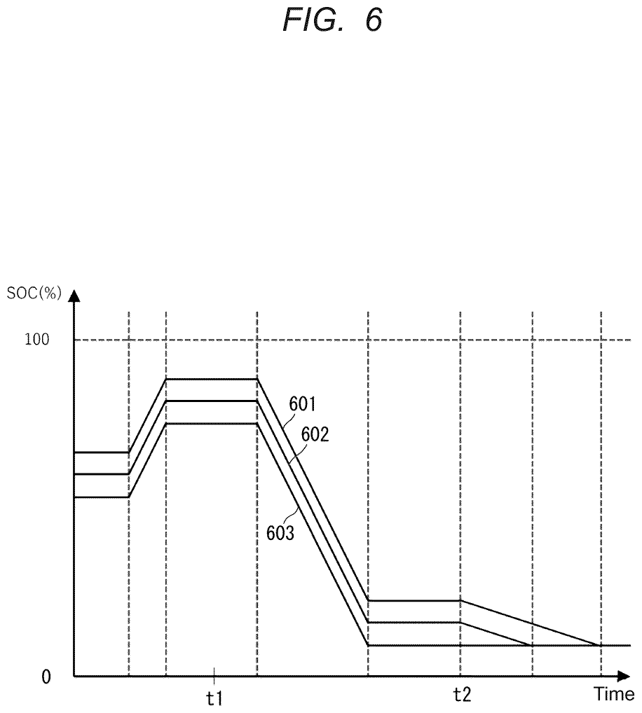

Next, with reference to FIGS. 2 to 6, an example of the processing of the control unit 115 according to the embodiment will be described. FIG. 2 is a flowchart showing an example of the processing of the control unit 115 according to the embodiment. FIG. 3 is a diagram showing an example of data recorded in a SOC-OCV table according to the embodiment. FIG. 4 is a diagram showing an example of a relationship between a capacity and voltage of each battery cell according to the embodiment. FIGS. 5 and 6 are timing charts showing an example of a timing of the cell balance processing according to the embodiment. The processing of FIG. 2 may be executed, for example, at regular timings in a no-load condition (a state where no load is connected to the battery cells and no current flows in or out of the battery cells).

In step S101, the control unit 115 estimates a charge rate SOC1[i] of each of the battery cells C1 to Cn at the first time point, based on a voltage of each of the battery cells C1 to Cn measured by the voltage measurement circuit 113 at the first time point. It should be noted that i is an index for each battery cell, and can be any value from 1 to n.

Here, for example, the control unit 115 may acquire the voltage measurements of each battery cell after a specific time has elapsed in an unloaded state (a state where no load is coupled to the battery cell and no current flows in or out of the battery cell) (for example, the time it takes for a power of the battery cell to stabilize after stopping a power supply from the battery cell).

For example, the control unit 115 may use a table (SOC (State of Charge)-OCV (Open Circuit Voltage) table) that associates each voltage value of the battery cell with each charge rate value of the battery cell, to obtain the charge rate corresponding to the measured voltage value. It should be noted that the SOC-OCV table may be generated by prior experiments or simulations and registered (set, recorded) in the control unit 115 or the like.

FIG. 3 shows an example of the charge rate values of the battery cells for each voltage value recorded in the SOC-OCV table related to the embodiment. In the example of FIG. 3, a curve 301 is shown indicating that the higher the voltage of the battery cell, the higher the charge rate.

Additionally, for example, the control unit 115 may calculate an estimated charge rate corresponding to the measured voltage value using a function or the like for calculating the charge rate value from the voltage value of the battery cell. In this case, for example, the control unit 115 may estimate (infer) the charge rate value from the voltage value of the battery cell using AI (Artificial Intelligence) or the like.

Subsequently, in step S102, control unit 115 estimates the charge rate SOC2[i] of each of the battery cells C1 to Cn at the second time point, based on a voltage of each of the battery cells C1 to Cn measured by the voltage measurement circuit 113 at the second time point.

Here, for example, the control unit 115 may acquire the voltage measurements of each battery cell after a specific time has elapsed in an unloaded state. The control unit 115 may estimate the charge rate SOC2[i] of each battery cell using the same method as described in the step S101.

The first time point may be close to full discharge (voltage at the end of discharge), and the second time point may be close to full charge. It should be noted that the first time point may be on a side close to full charge, and the second time point may be on a side close to full discharge. In this case, for example, the control unit 115 may determine whether the lowest voltage among the voltages of each of the battery cells C1 to Cn is within a predetermined range corresponding to the voltage of full discharge (full discharge side predetermined range). It should be noted that the full discharge side predetermined range may be registered (set, recorded) in the control unit 115 or the like by an operator (administrator) or the like. Then, for example, the control unit 115 may execute the processing of the step S101 when the lowest voltage is within the full discharge side predetermined range. And the control unit 115 may determine whether the highest voltage among the voltages of each of the battery cells C1 to Cn is within a predetermined range (full charged side predetermined range) corresponding to the voltage at full charge. The full charge side predetermined range may be registered (set, recorded) in the control unit 115 or the like by an operator (administrator) or the like. And the control unit 115 may execute the processing of the step S102, for example, when the highest voltage is within the full charge side predetermined range.

FIG. 4 shows an example of the relationship between the capacity and voltage of each battery cell according to the embodiment. In the example of FIG. 4, an example of the voltage value 401 for each capacity of the battery cell C1, the voltage value 402 for each capacity of the battery cell C2, and the voltage value 403 for each capacity of the battery cell Cn are shown. The control unit 115 may, for example, take the timing when the capacity of each battery cell is capacity 411 as the first time point, and the timing when the capacity of each battery cell is capacity 412 as the second time point.

Contrary to the above, the first time point may be when the charge rate is close to full charge, and the second time point may be when the charge rate is close to full discharge. In this case, the control unit 115 may, for example, take the timing when the capacity of each battery cell is capacity 412 as the first time point, and the timing when the capacity of each battery cell is capacity 411 as the second time point. In this case, the control unit 115 may determine whether the highest voltage among the voltages of each of the battery cells C1 to Cn is within the full charge side predetermined range. And the control unit 115 may execute the processing of the step S101, for example, when the highest voltage is within the full charge side predetermined range. And the control unit 115 may determine whether the lowest voltage among the voltages of each of the battery cells C1 to Cn is within the full discharge side predetermined range. And the control unit 115 may execute the processing of the step S102, for example, when the lowest voltage is within the full discharge side predetermined range.

It should be noted that the predetermined range on the full charge side and the predetermined range on the full discharge side may be previously registered (set, recorded) in the control unit 115 or the like. In this case, the upper and lower limits of the predetermined range on the full charge side and the upper and lower limits of the predetermined range on the full discharge side may be previously registered. In this case, the predetermined range on the full charge side may be, for example, a range of voltages lower than the voltage of the battery cell at full charge. Furthermore, the predetermined range on the full discharge side may be, for example, a range of voltages higher than the discharge end voltage of the battery cell. It should be noted that the control unit 115 may update the predetermined range on the full charge side and the predetermined range on the full discharge side using AI or the like.

Subsequently, the control unit 115 calculates an integrated value Σc (absolute value) of the current flowing through the battery cells C1 to Cn during a period from the first time point to the second time point, measured by the current measurement circuit 114 (step S103). It should be noted that a unit of the integrated value Σc may be, for example, Ah (Ampere-hour) or mAh (milliampere-hour). It should be noted that since the battery cells C1 to Cn are coupled in series, the current value flowing through each battery cell is the same, and the value of the integrated value Σc for each battery cell is the same.

Subsequently, the control unit 115 estimates a maximum capacity (battery capacity at 100% charge rate (full charge)) of each of the battery cells C1 to Cn. The unit may be, for example, Ah or mAh) Qmax[i](step S104). Here, the control unit 115 may calculate the estimated value of the maximum capacity of each battery cell by the following equation (1).

$${Q}_{max} [ i ] = \sum c / ( {SOC}_{1} [ i ] - {SOC}_{2} [ i ] ) \qquad ( 1 )$$

It should be noted that the processes of step S105 and step S106 may be executed at any timing, for example, periodically. In this case, the control unit 115 may execute the processes of step S105 and step S106 at a timing after a predetermined time has passed in an unloaded state, for example. It should be noted that, for example, when the battery pack 10 is charged or discharged while performing cell balance control (at least one of the processes of step S105 and step S106), the control unit 115 may temporarily stop the cell balance control. Then, the control unit 115 may execute the processes of step S105 and step S106 again when a predetermined time has passed again in an unloaded state. As a result, for example, cell balance control can be performed without repeating the process up to step S104 of estimating the maximum capacity of each of the battery cells C1 to Cn.

Subsequently, based on the estimated maximum capacity of each battery cell and the current charge rate of each battery cell, the control unit 115 determines a reference cell from among the battery cells C1 to Cn and determines the discharge period for each battery cell other than the reference cell (step S105). As a result, for example, the accuracy of ATTF (Average Time to Full) and ATTE (Average Time To Empty) defined in the PC battery standard Smart Battery Data Specification can be improved.

### Example of Matching the Capacity of Each Battery Cell at Full Charge

The control unit 115 may, for example, determine the discharge period for each battery cell to match the capacities of each battery cell at full charge (for example, when the charge rate of each battery cell reaches 100%). As a result, for example, since the capacities of each battery cell match at full charge, it is possible to reduce the occurrence of overcharging the battery cells.

In this case, the control unit 115 may, for example, estimate the capacity to full charge ToMAXCap[i] for each battery cell based on the maximum capacity Qₘₐₓ[i] of each battery cell and the current charge rate SOC₃[i] of each battery cell (for example, at a second time point). Furthermore, the control unit 115 may estimate the charge rate SOC₃[i] of each battery cell based on the voltage of each battery cell measured by the voltage measurement circuit 113, using a method similar to the aforementioned step S101.

Then, the control unit 115 may, for example, calculate the capacity to full charge (available capacity) ToMAXCap[i] for each battery cell by the following equation (2).

$$To MAX Cap [ i ] = {Q}_{max} [ i ] \times ( 100 - SOC 3 [ i ] ) \qquad ( 2 )$$

Then, the control unit 115 may, for example, determine the battery cell Ck, among battery cells C1 to Cn, with the maximum value of capacity to full charge ToMAXCap[i], as the reference battery cell.

Then, the control unit 115 may, for example, determine the discharge period CBTime[j] for each battery cell Cj based on ToMAXCap[k] of the reference battery cell Ck and ToMAXCap[j] of each battery cell Cj other than the reference battery cell Ck. Here, j is an index for each battery cell other than the reference battery cell Ck, and is a value other than k among 1 to n.

Then, the control unit 115 may, for example, determine the discharge period (cell balance time) CBTime[j] for each battery cell Cj by the following equation (3).

$$CBTime [ j ] = ( To MAX Cap [ k ] - To MAX Cap [ j ] / BalCurr \qquad ( 3 )$$

As a result, it is possible to discharge each battery cell Cj, other than the reference battery cell Ck, for a period until the capacity to full charge of each battery cell Cj becomes identical to the capacity to full charge of the reference battery cell Ck. Here, BalCurr is the discharge current value of the battery cell Cj when the switch Sj for the battery cell Cj in cell balance selection 111 is turned ON. The value of BalCurr may be pre-registered (set, recorded) in the control unit 115 or the like.

Furthermore, the control unit 115 may, for example, execute the process to match the capacities of each battery cell at full charge when the highest voltage among the voltages of each battery cell is within a predetermined range on the full charge side. As a result, for example, cell balance processing is executed when one or more battery cells are near full charge, further reducing the possibility of overcharging the battery cells.

FIG. 5 shows an example of the transition 501-503 of the charge rates of battery cells C1, C2, Cn according to the embodiment. In the example of FIG. 5, the process of the step S101 is executed at the first time point t1, where the lowest voltage among the voltages of battery cells C1 to Cn is within a predetermined range on the full discharge side. Furthermore, at the second time point t2, where the highest voltage among the voltages of each of the battery cells C1 to Cn is within a predetermined range on the full charge, the process from the step S102 to the step S106 described later is executed.

### Example of Matching the Capacity of Each Battery Cell at Full Discharge

The control unit 115 may determine the discharge period for each battery cell so as to match the capacity of each battery cell at the time of full discharge (deep discharge, at the discharge end voltage, for example, when the charge rate of each battery cell is approximately 0%). As a result, for example, since the capacity of each battery cell matches at the time of full discharge, it is possible to reduce the occurrence of over-discharge in the battery cells.

In this case, the control unit 115 may estimate the capacity (remaining capacity) ToMINCap[i] until full discharge of each battery cell based on, for example, the maximum capacity Qmax[i] of each battery cell and the current charge rate SOC4[i] of each battery cell (for example, at the second time point). Furthermore, the control unit 115 may estimate the charge rate SOC₄[i] of each battery cell based on the voltage of each battery cell measured by the voltage measurement circuit 113, using a method similar to that described in the step S101.

Then, the control unit 115 may calculate the capacity ToMINCap[i] until full discharge of each battery cell, for example, by the following equation (4).

$$To MIN Cap [ i ] = {Q}_{max} [ i ] \times ( SOC 4 [ i ] ) \qquad ( 4 )$$

Then, the control unit 115 may determine, for example, the battery cell Ck with the smallest value of capacity ToMINCap[i] until full discharge among the battery cells C1 to Cn as the reference battery cell.

Then, the control unit 115 may determine the discharge period CBTime[j] for each battery cell Cj based on the ToMINCap[k] of the reference battery cell Ck and the ToMINCap[j] of each battery cell Cj other than the reference battery cell Ck, for example. As described above, j is an index for each battery cell other than the reference battery cell Ck, and is a value other than k among 1 to n.

Then, the control unit 115 may determine the discharge period (cell balance time) CBTime[j] for each battery cell Cj, for example, by the following equation (5).

$$CBTime [ j ] = ( To MIN Cap [ j ] - To MIN Cap [ k ] ) / BalCurr \qquad ( 5 )$$

As a result, it is possible to discharge each battery cell Cj other than the reference battery cell Ck for a period until the capacity until full discharge of each battery cell Cj becomes identical to the capacity until full discharge of the reference battery cell Ck.

Furthermore, the control unit 115 may execute the process of matching the capacity of each battery cell at the time of full discharge when the lowest voltage among the voltages of each battery cell is within a predetermined range of full discharge. As a result, for example, when one or more battery cells are near full discharge, cell balance processing is executed, thereby further reducing the occurrence of over-discharge in the battery cells.

FIG. 6 shows an example of the transition 601 to 603 of the charge rate of each of the battery cells C1, C2, Cn according to the embodiment. In the example of FIG. 6, at a first time point t1 where the highest voltage among the voltages of each of the battery cells C1 to Cn is within a predetermined range on the full charge side, the process of the step S101 is executed. Furthermore, at a second time point t2 where the lowest voltage among the voltages of each of the battery cells C1 to Cn is within a predetermined range on the full discharge side, the processes from the step S102 to the subsequently described step S106 are executed.

### Example of Matching the Capacity of Each Battery Cell at Full Charge and Discharge

The control unit 115 may execute the process of matching the capacity of each battery cell at full charge and the process of matching the capacity of each battery cell at full discharge at different timings. As a result, for example, the capacity of each battery cell at full charge and full discharge can be matched, thereby reducing the possibility of overcharging and overdischarging of the battery cells.

In this case, for example, the control unit 115 may execute the process of matching the capacity of each battery cell at full charge when the highest voltage among the voltages of each battery cell is within a predetermined range on the full charge side. Furthermore, the control unit 115 may execute the process of matching the capacity of each battery cell at full discharge when the lowest voltage among the voltages of each battery cell is within a predetermined range corresponding to the voltage at full discharge.

Subsequently, the control unit 115 discharges each of the battery cells Cj other than a reference cell among battery cells C1 to Cn (step S106). Here, for example, the control unit 115 may discharge for cell balance by turning on the switch Sj for one or more of the battery cells Cj in cell balance section 111 for a period of time calculated as CBTime[j]. This allows, for example, to eliminate the need for cell balance control commands from the system side (main body 20 side) and to perform cell balance solely on the battery pack 10 side. Furthermore, for example, cell balance control can be performed without the user's awareness, such as when the equipment 1 is in a long-term storage state without use. Also, cell balance control on the discharge side becomes possible.

It is known that differences in degradation speed of each cell can occur due to differences in operating environments and variations during manufacturing. In this case, differences in the capacity of each cell will occur. Even if the capacities of each cell are the same, the charge rates of each cell may differ. Therefore, even if cell balancing is performed to equalize the voltages of each cell, the capacities of the cells may not match. According to this disclosure, even if both the capacity and the charge rate of each cell vary, more appropriate cell balance control can be performed.

### <About Control Unit 115>

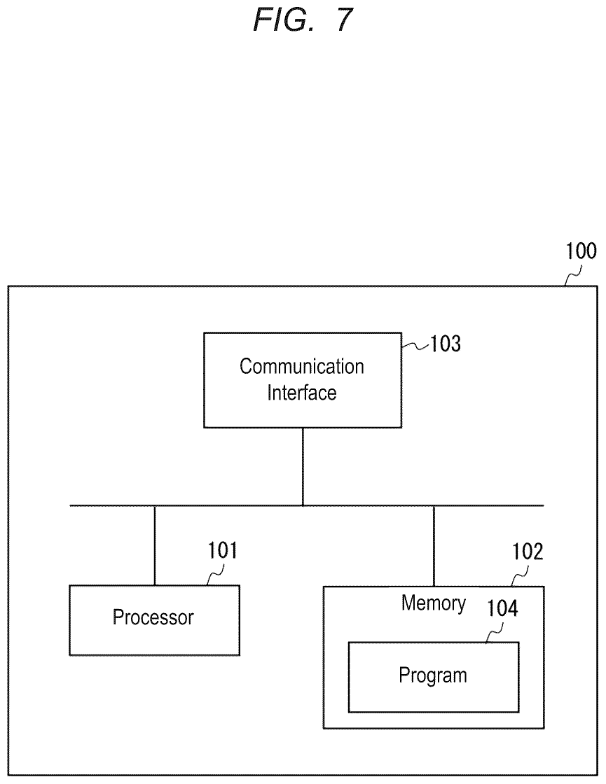

FIG. 7 is a diagram showing an example of the configuration of the control unit 115 according to the embodiment. In the example of FIG. 7, the control unit 115 includes a processor 101, a memory 102, and a communication interface 103. These components may be coupled by a bus or the like. The memory 102 stores at least a part of the program 104. The communication interface 103 includes interfaces necessary for communication with other network elements.

When the program 104 is executed by the cooperation of the processor 101 and the memory 102, etc., at least a part of the processes of the embodiment of this disclosure is performed by the computer 100. The memory 102 may be of any type. The memory 102, as a non-limiting example, may be a non-transitory computer-readable storage medium. Furthermore, the memory 102 may be implemented using any appropriate data storage technology such as semiconductor-based memory devices, magnetic memory devices and systems, optical memory devices and systems, fixed memory, and removable memory. Although only one the memory 102 is shown in the computer 100, there may be several physically different memory modules present in the computer 100. The processor 101 may be of any type. The processor 101 may include one or more processors based on a general-purpose computer, a special purpose computer, a microprocessor, a digital signal processor (DSP), and as a non-limiting example, a multicore processor architecture. The computer 100 may have multiple processors, such as a specific application integrated circuit chip that is temporally dependent on the clock that synchronizes the main processor.

The program can be stored using various types of non-transitory computer-readable media and supplied to the computer. Non-transitory computer-readable media includes various types of tangible recording media. Examples of non-transitory computer-readable media include magnetic recording media, magneto-optical recording media, optical disc media, semiconductor memory, etc. Magnetic recording media include, for example, flexible disks, magnetic tapes, hard disk drives, etc. Magneto-optical recording media include, for example, magneto-optical disks, etc. Optical disc media include, for example, Blu-ray discs, CD (Compact Disc)-ROM (Read Only Memory), CD-R (Recordable), CD-RW (ReWritable), etc. Semiconductor memory includes, for example, solid-state drives, mask ROM, PROM (Programmable ROM), EPROM (Erasable PROM), flash ROM, RAM (random access memory), etc. Furthermore, the program may also be supplied to the computer by various types of transitory computer-readable media. Examples of transitory computer-readable media include electrical signals, optical signals, and electromagnetic waves. Transitory computer-readable media can supply the program to the computer via wired communication paths, such as electrical wires and optical fibers, or via wireless communication paths.

Above, the invention made by the inventor has been specifically described based on the embodiment, but the present invention is not limited to the embodiment already described, and it is needless to say that various modifications can be made without departing from the gist thereof.

What is claimed is:

1. A semiconductor device comprising:
a voltage measurement circuit configured to measure a voltage of each of a first battery cell and a second battery cell coupled in series,
a current measurement circuit configured to measure a current flowing through the first battery cell and the second battery cell, and
a control unit configured to control a discharge of at least one of the first battery cell and the second battery cell,
wherein the control unit estimates a charge rate of each of the first battery cell and the second battery cell at a first time point based on a voltage of each of the first battery cell and the second battery cell measured by the voltage measurement circuit at the first time point,
estimates a charge rate of each of the first battery cell and the second battery cell at a second time point, different from the first time point, based on a voltage of each of the first battery cell and the second battery cell measured by the voltage measurement circuit at the second time point,
calculates an integrated value of a current flowing through the first battery cell and the second battery cell during a period from the first time point to the second time point,
estimates a maximum capacity of the first battery cell based on the charge rate of the first battery cell at the first time point, the charge rate of the first battery cell at the second time point, and the integrated value of the current,
estimates a maximum capacity of the second battery cell based on the charge rate of the second battery cell at the first time point, the charge rate of the second battery cell at the second time point, and the integrated value of the current flowing through the second battery cell,
determines a reference battery cell from among the first battery cell and the second battery cell based on the maximum capacity of the first battery cell, the charge rate of the first battery cell, the maximum capacity of the second battery cell, and the charge rate of the second battery cell, and
discharge a battery cell other than the reference battery cell among the first battery cell and the second battery cell.

2. The semiconductor device according to claim 1, wherein the control unit estimates a capacity until full charge of the first battery cell based on the estimated maximum capacity of the first battery cell and the charge rate of the first battery cell,
estimates a capacity until full charge of the second battery cell based on the estimated maximum capacity of the second battery cell and the charge rate of the second battery cell, and
determines a battery cell with the largest capacity until full charge from among the first battery cell and the second battery cell as the reference battery cell.

3. The semiconductor device according to claim 2, wherein the control unit discharges a battery cell other than the reference battery cell among the first battery cell and the second battery cell for a period until the capacity until full charge of the battery cell becomes identical to the capacity until full charge of the reference battery cell.

4. The semiconductor device according to claim 2, wherein the control unit estimates the charge rate of each of the first battery cell and the second battery cell at the first time point when the lowest voltage among the voltage of the first battery cell and the second battery cell is within a predetermined range corresponding to a voltage at full discharge, and
estimates the charge rate of each of the first battery cell and the second battery cell at the second time point when the highest voltage among the voltage of the first battery cell and the second battery cell is within a predetermined range corresponding to a voltage at full charge.

5. The semiconductor device according to claim 2, wherein the control unit discharges the battery cell other than the reference battery cell among the first battery cell and the second battery cell when the highest voltage among the voltage of the first battery cell and the second battery cell is within a predetermined range corresponding to a voltage at full charge.

6. The semiconductor device according to claim 1, wherein the control unit estimates a capacity until full discharge of the first battery cell based on the estimated maximum capacity of the first battery cell and the charge rate of the first battery cell, and
estimates the capacity until full discharge of the second battery cell based on the estimated maximum capacity of the second battery cell and the charge rate of the second battery cell, and
determines the battery cell with the smallest capacity until full discharge from among the first battery cell and second battery cell as the reference battery cell.

7. The semiconductor device according to claim 6, wherein the control unit discharges the battery cell other than the reference battery cell among the first and second battery cells for a period until the capacity until full discharge of the battery cell becomes identical to the capacity until full discharge of the reference battery cell.

8. The semiconductor device according to claim 6, wherein the control unit estimates the charge rate of the first and second battery cells at the first time point when the highest voltage among the voltages of the first and second battery cells is within a predetermined range corresponding to a voltage at full charge, and estimates the charge rate of the first and second battery cells at the second time point when the lowest voltage among the voltages of the first and second battery cells is within a predetermined range corresponding to a voltage at full discharge.

9. The semiconductor device according to claim 6, wherein the control unit discharges the battery cell other than the reference battery cell among the first and second battery cells when the lowest voltage among the voltages of the first and second battery cells is within a predetermined range corresponding to a voltage at full discharge.

10. A method of controlling cell balance comprising:
measuring a voltage of each of a first battery cell and a second battery cell coupled in series,
measuring a current flowing through the first battery cell and the second battery cell,
estimating a charge rate of each of the first battery cell and the second battery cell at a first time point based on a measured voltage of each of the first battery cell and the second battery cell at the first time point,
estimating a charge rate of each of the first battery cell and the second battery cell at a second time point, different from the first time point, based on a measured voltage of each of the first battery cell and second battery cell at the second time point,
calculating an integrated value of a current flowing through the first battery cell and second battery cell during a period from the first time point to the second time point,
estimating a maximum capacity of the first battery cell based on the charge rate of the first battery cell at the first time point, the charge rate of the first battery cell at the second time point, and the integrated value of the current,
estimating a maximum capacity of the second battery cell based on the charge rate of the second battery cell at the first time point, the charge rate of the second battery cell at the second time point, and the integrated value of the current,
determining a reference battery cell from among the first battery cell and second battery cell based on the maximum capacity of the first battery cell, the charge rate of the first battery cell, the maximum capacity of the second battery cell, and the charge rate of the second battery cell, and
discharging a battery cell other than the reference battery cell among the first battery cell and the second battery cell.

11. The method of controlling cell balance according to claim 10, wherein the step of determining the reference battery cell further comprises,
estimating a capacity until full charge of the first battery cell based on the estimated maximum capacity of the first battery cell and the charge rate of the first battery cell,
estimating a capacity until full charge of the second battery cell based on the estimated maximum capacity of the second battery cell and the charge rate of the second battery cell, and
determining a battery cell with the largest capacity until full charge from among the first battery cell and the second battery cell as the reference battery cell.

12. The method of controlling cell balance according to claim 11, wherein the step of discharging the battery cell other than the reference battery cell among the first battery cell and the second battery cell further comprises,
discharging the battery cell for a period until the capacity until full charge of the battery cell becomes identical to the capacity until full charge of the reference battery cell.

13. The method of controlling cell balance according to claim 11, wherein
the step of estimating the charge rate of each of the first battery cell and the second battery cell at the first time point is performed when the lowest voltage among the voltages of the first cell and second battery cell is within a predetermined range corresponding to a voltage at full discharge, and
the step of estimating the charge rate of each of the first battery cell and the second battery cell at the second time point is performed when the highest voltage among the voltages of the first cell and second battery cell is within a predetermined range corresponding to a voltage at full charge.

14. The method of controlling cell balance according to claim 11, wherein in the step of discharging the battery cell other than the reference battery cell is performed when the highest voltage among the voltage of the first battery cell and the second battery cell is within a predetermined range corresponding to a voltage at full charge.

15. The method of controlling cell balance according to claim 10, wherein the step of determining the battery cell as the reference battery cell further comprises,
estimating a capacity until full discharge of the first battery cell based on the estimated maximum capacity of the first battery cell and the charge rate of the first battery cell, and
estimating a capacity until full discharge of the second battery cell based on the estimated maximum capacity of the second battery cell and the charge rate of the second battery cell, and
determining the battery cell with the smallest capacity until full discharge from among the first and second battery cells as the reference battery cell.

16. The method of controlling cell balance according to claim 15, wherein the step of discharging the battery cell other than the reference battery cell among the first and second battery cells is performed for a period until the capacity until full discharge of the battery cell becomes identical to the capacity until full discharge of the reference battery cell.

17. The method of controlling cell balance according to claim 15, wherein
the step of estimating the charge rate of the first battery cell and the second battery cell at the first time point is performed when the highest voltage among the voltages of the first and second battery cells is within a predetermined range corresponding to a voltage at full charge,
the step of estimating the charge rate of the first battery cell and the second battery cell at the second time point is performed when the lowest voltage among the voltages of the first and second battery cells is within a predetermined range corresponding to a voltage at full discharge.

18. The method of controlling cell balance according to claim 15, wherein the step of discharging the battery cell other than the reference battery cell among the first and second battery cells is performed when the lowest voltage is within a predetermined range corresponding to a voltage at the time of full discharge.

19. A battery pack comprising:
a first battery cell and a second battery cell coupled in series,
a voltage measurement circuit configured to measure a voltage of each of the first battery cell and the second battery cell,
a current measurement circuit configured to measure a current flowing through the first battery cell and the second battery cell, and
a control unit configured to control a discharge of at least one of the first battery cell and the second battery cell,
wherein the control unit estimates a charge rate of each of the first battery cell and the second battery cell at a first time point based on a voltage of each of the first battery cell and the second battery cell measured by the voltage measurement circuit at the first time point,
estimates a charge rate of each of the first battery cell and the second battery cell at a second time point, different from the first time point, based on a voltage of each of the first battery cell and the second battery cell measured by the voltage measurement circuit at the second time point,
calculates an integrated value of a current flowing through the first battery cell and the second battery cell during a period from the first time point to the second time point,
estimates a maximum capacity of the first battery cell based on the charge rate of the first battery cell at the first time point, the charge rate of the first battery cell at the second time point, and the integrated value of the current,
estimates a maximum capacity of the second battery cell based on the charge rate of the second battery cell at the first time point, the charge rate of the second battery cell at the second time point, and the integrated value of the current,
determines a reference battery cell from among the first battery cell and the second battery cell based on the maximum capacity of the first battery cell, the charge rate of the first battery cell, the maximum capacity of the second battery cell, and the charge rate of the second battery cell, and
discharges a battery cell other than the reference battery cell among the first battery cell and the second battery cell.
